(19) United States
(12) Patent Application Publication
(10) Pub. No.: US 2008/0189486 A1
(43) Pub. Date: Aug. 7, 2008

(54) USB Flash Memory Devices with An Improved Cap

(75) Inventors: David Nguyen, San Jose, CA (US); Nan Nan, San Jose, CA (US); Jim Chin-Nan Ni, San Jose, CA (US); Charles C. Lee, Cupertino, CA (US); Ming-Shiang Shen, Taipei Hsien (TW)

Correspondence Address: ROGER H. CHU, 19499 ERIC DRIVE, SARATOGA, CA, 95070, US

(73) Assignee: SUPER TALENT ELECTRONICS, INC., San Jose, CA (US)

(21) Appl. No.: 11/928,113

(22) Filed: Oct. 30, 2007

Related U.S. Application Data
(63) Continuation-in-part of application No. 11/624,667, filed on Jan. 18, 2007.
Application No. 11/624,667 is a division of application No. 09/478,720, filed on Jan. 6, 2000, now Pat. No. 7,257,714.
Application No. 09/478,720 is a continuation-in-part of application No. 10/991,313, filed on Nov. 16, 2004, now Pat. No. 7,296,345.
Application No. 10/991,313 is a continuation-in-part of application No. 10/309,594, filed on Jan. 22, 2003, now abandoned.
Application No. 10/309,594 is a continuation-in-part of application No. 11/309,847, filed on Oct. 12, 2006.
Application No. 11/309,847 is a continuation-in-part of application No. 11/466,759, filed on Aug. 23, 2006.
Application No. 11/466,759 is a continuation-in-part of application No. 10/789,333, filed on Feb. 26, 2004, now Pat. No. 7,318,117.

(51) Int. Cl. G06F 12/00

(52) U.S. Cl. 711/115; 711/E12.008

(57) ABSTRACT

USB flash memory devices with an improved cap are described. According to an exemplary embodiment of the invention, a USB flash memory device comprises a flash memory drive, an improved cap, a cap plug and a wire loop. The flash memory drive comprises a core unit and an outer shell structure. The cap comprises a substantially slab-shaped hollow structure with rounded edges and rounded corners, having an open end and a closed end, two opposing side walls, a top surface and a bottom surface. The cap is configured to substantially encase the entire flash memory drive through the open end, when the flash memory drive is in a closed configuration. The cap plug is configured to plug into the cap, when the flash memory drive is in an open configuration. The wire loop is configured to link the flash memory drive and the cap plug together in one location.

### CROSS-REFERENCE TO RELATED APPLICATIONS

This application is a continuation-in-part (CIP) of a co-pending U.S. Patent Application for “Electronic Data Storage Medium with Fingerprint Verification Capability”, Ser. No. 11/624,667, filed Jan. 18, 2007, which is a divisional application of U.S. patent application Ser. No. 09/478,720, filed on Jan. 6, 2000, now U.S. Pat. No. 7,257,714, which has been petitioned to claim the benefit of CIP status of one of inventor's earlier U.S. Patent application for “Integrated Circuit Card with Fingerprint Verification Capability”, Ser. No. 09/366,976, filed on Aug. 4, 1999, now issued as U.S. Pat. No. 6,547,130.

This application is also a CIP of co-pending U.S. Patent Application for “A Method for Manufacturing a Memory Device”, Ser. No. 10/991,313, filed on Nov. 16, 2004.

This application is also a CIP of co-pending U.S. Patent Application for “Single-Chip Multi-Media Card/Secure Digital (MMC/SD) Controller Reading Power-On Boot Code from Integrated Flash Memory for User Storage”, Ser. No. 11/309,594, filed on Aug. 28, 2006, which is a CIP of U.S. Patent Application for “Single-Chip USB Controller Reading Power-On Boot Code from Integrated Flash Memory for User Storage”, Ser. No. 10/707,277, filed on Dec. 2, 2003, now U.S. Pat. No. 7,103,684.

This application is also a CIP of co-pending U.S. Patent Application for “USB Device with Integrated USB Plug with USB Substrate Supporter Inside”, Ser. No. 11/309,847, filed on Oct. 12, 2006.

This application is also a CIP of co-pending U.S. Patent Application for “Flash Memory Controller for Electronic Data Flash Card”, Ser. No. 11/466,759, filed on Aug. 23, 2006, which is a CIP of U.S. Patent Application for “System and Method for controlling Flash Memory”, Ser. No. 10/789,333, filed on Feb. 26, 2004.

### FIELD OF THE INVENTION

The present invention relates to portable electronic storage devices such as Universal Serial Bus (USB) flash drive, and more particularly to USB flash drives with an improved cap for protecting fingerprint verification sensor.

### BACKGROUND OF THE INVENTION

Portable electronic storage devices have become widely accepted and used by consumers. For example, Universal-Serial-Bus (USB) flash memory device has been used for storing digital information such as data files, photos, video clips, digital music files, audio messages, etc. A USB device includes a main body and a connector. While the main body provides the flash memory storage, the connector provides an interface to outside devices. In a data exchange operation, the connector is plugged into a host (e.g., a personal computer, a consumer electronic device, etc.). Data files are exchanged (i.e., read or written) between the USB device and the host. To ensure data exchange operations work well mechanically and electrically, the connector needs to be kept in a good condition (e.g., no dents or scratches, cleanness, etc.). A prior approach for protecting the connector comprises a short cap, which covers the length of the USB connector. However, there are shortcomings with the prior art cap.

First, the prior art cap is very short and small hence very easy to be misplaced or lost when the cap is removed during data exchange operations. Second, because the prior art cap can only cover very short length, only the connector is protected. The main body is still subjected to damage. Additionally, with increasing demand of data security, many of the USB flash memory devices include a fingerprint sensor, which requires a cover to shield the sensor from getting dirty. The prior art cap can only protect the connector not other area such as the sensor of the USB flash memory device.

Therefore it would be desirable to have a USB flash memory device that includes an improved cap that is not easy to be misplaced and provides protections to more than just the connector.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

USB flash memory devices with an improved cap are disclosed. According to an exemplary embodiment of the present invention, a USB flash memory device comprises a USB flash memory drive, an improved cap, a cap plug and a wire loop. The USB flash memory drive comprises a flash memory core unit and an outer shell structure. The core unit includes flash memory, a controller (e.g., flash memory controller) and a connector (e.g., a USB connector) mounted on a medium means that may be a print circuit board, a flex circuit board or a lead frame. The core unit may also include a fingerprint sensor included in a fingerprint processor. The connector may be a standard USB connector or a manufactured connector with a metal wrap and contact fingers. The outer shell structure may be formed by coupling an upper housing and a lower housing together with a seal means such as ultrasound welding technique or mechanical connection using several snap-in tabs and corresponding slot receptacles.

The improved cap comprises a substantially slab-shaped hollow structure with rounded edges and rounded corners, having an open end and a closed end, two opposing side walls, a top surface and a bottom surface. The cap is configured to substantially encase the entire flash memory drive through the open end, when the flash memory drive is in a closed (i.e., not-in-use) configuration. In other words, the length of the cap is substantially equal to the length of the flash memory drive. Therefore, the cap can provide protection to not only the connector but the outer shell structure of the flash memory drive. The additional protection is vital, when the flash memory drive includes an optional fingerprint sensor.

The cap plug comprises a top end block, a middle block and a plug end block. The plug end block is so dimensioned that the cap plug can be plugged into the cap, when the flash memory drive is in an open configuration (i.e., ready-to-be-used or in-use in a data exchange operation). The wire loop (e.g., a key chain) is configured to link the flash memory drive and the cap plug by threading through a pair of open slots on the outer shell structure of the flash memory drive and a hole in the top end block of the cap plug.

In one aspect of the present invention, the flash memory drive comprises a pair of protrusion snap-in connectors configured to snap into a pair of corresponding slots located on the inner surface of each of the side walls of the cap. Therefore, the cap is securely locked to the flash memory drive. As a result, the cap is not very easy to be dropped or lost.

In another aspect, the cap plug comprises a pair of protrusion snap-in connectors (same type located on the flash memory drive) located on either side of the plug end. Similar to the connectors on the flash memory drive, the connectors are configured to couple with the pair of corresponding slots of the cap. The cap is securely locked to the cap plug, once the connectors are snapped into the slots.

In yet another aspect, when the cap is plugged into the cap plug, all components of the USB flash memory device are linked in one location through the wire loop.

According to one exemplary embodiment of the present invention, a USB flash memory device includes at least the following: a USB flash memory drive including an outer shell structure and a USB flash memory core unit assembled therein, the outer shell structure is formed by an upper housing and a lower housing; a cap plug including a top end block, a middle block and a plug end block, the middle block is configured to connect the top end block and the plug end block; a loop means for linking the USB flash memory drive and the cap plug together via two open slots on the outer shell housing structure of the USB flash memory drive and one hole on the top end block of the cap plug; and a cap configured to encase the entire USB flash memory drive when the USB flash memory drive is in a closed configuration and configured to cover the middle block and the plug end block of the cap plug when the USB flash memory drive in an open configuration.

The a USB flash memory core unit includes a medium means for mechanically support and electrically connect electrical components with conducting pathways; a connector means for coupling to a host based on USB specification, the connector means is electrically and physically connected to the medium means; a flash memory controller mounted on the medium means; and at least one flash memory integrated circuit mounted on the medium means.

One of the objects, features, and advantages of the present invention is that the entire flash memory drive is protected by an improved cap, while the cap is configured to be secured locked both in closed and open configurations. Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a perspective view showing an exemplary USB flash memory device in a closed configuration in accordance with one embodiment of the present invention;

FIG. 1B is a perspective view showing the USB flash memory device of FIG. 1A in an open configuration;

FIG. 1C is an exploded perspective view showing salient components of the USB flash memory device of FIG. 1A;

FIG. 1D is a perspective view showing the cap plug and the improved cap of the USB flash memory device of FIG. 1A;

FIG. 1E is another perspective view showing the improved cap of the USB flash memory device of FIG. 1A;

FIG. 1F is a plan view showing relative widths of the improved cap and the cap plug of the USB flash memory device of FIG. 1A;

FIG. 1G is a top perspective view showing an exemplary flash memory core unit of the USB flash memory device of FIG. 1A;

FIGS. 1H.1 and FIG. 1H.2 are respective top and bottom perspective views collectively showing upper housing of the USB flash drive of FIG. 1A;

FIG. 1I is a top perspective view showing lower housing of the USB flash memory drive of FIG. 1A;

FIGS. 2A-2B are perspective views showing of alternative wire loops may be used in other embodiments of the present invention;

FIGS. 3A-3C are a series of perspective views depicting an assembling sequence of the USB flash memory device of FIG. 1A, according to an embodiment of the present invention;

FIG. 4 is a perspective view illustrating an alternative USB flash memory drive without fingerprint sensor;

FIG. 5 is a perspective view showing another alternative USB flash memory core unit based on flex circuit;

FIG. 6A is an exploded perspective view showing yet another alternative USB flash memory core unit with a manufactured connector with a metal wrap and connector fingers;

FIGS. 6B and 6C are top and bottom perspective views showing the USB flash memory core unit of FIG. 6A, respectively;

FIG. 7A shows an exploded perspective view of yet anther alternative USB flash memory dive based on chip scale mounting technology; and

FIGS. 7B and 7C are top and bottom perspective views showing the USB flash memory drive of FIG. 7A, respectively.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the invention do not inherently indicate any particular order nor imply any limitations in the invention.

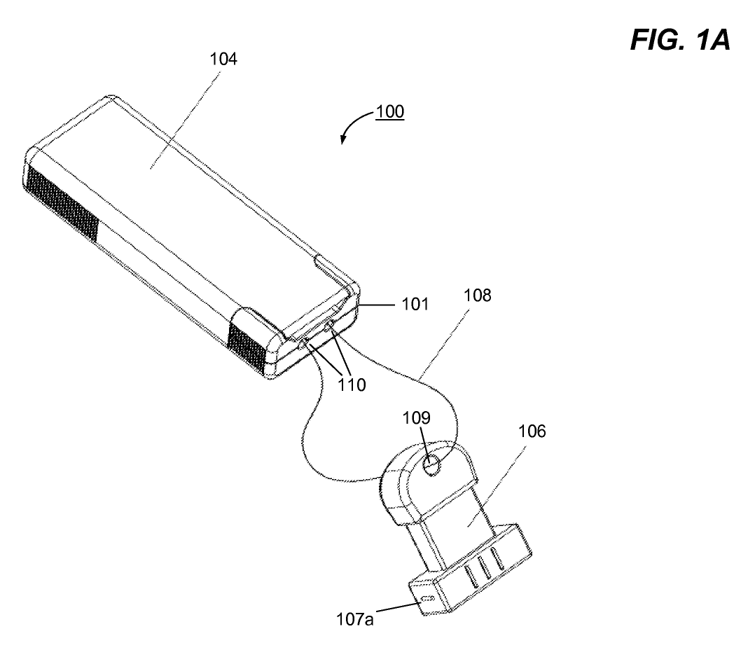

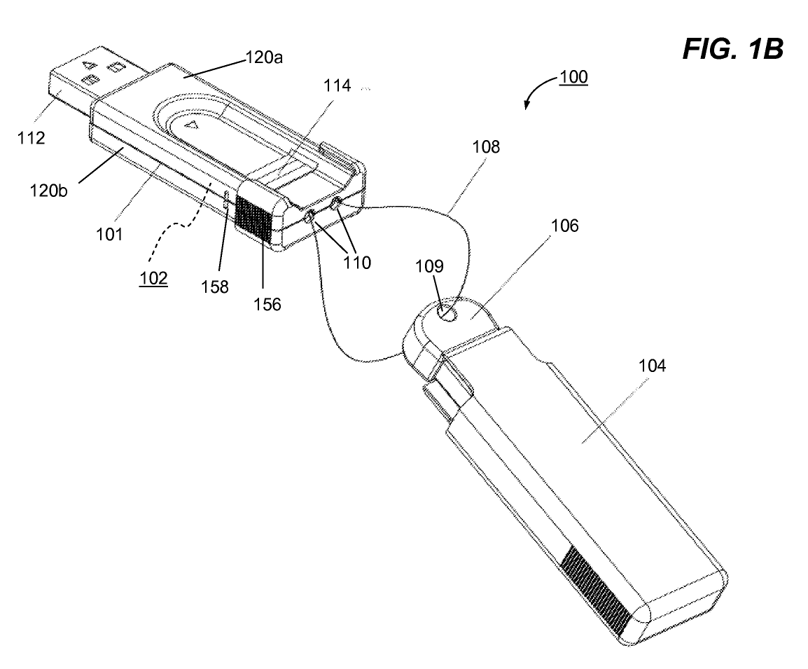

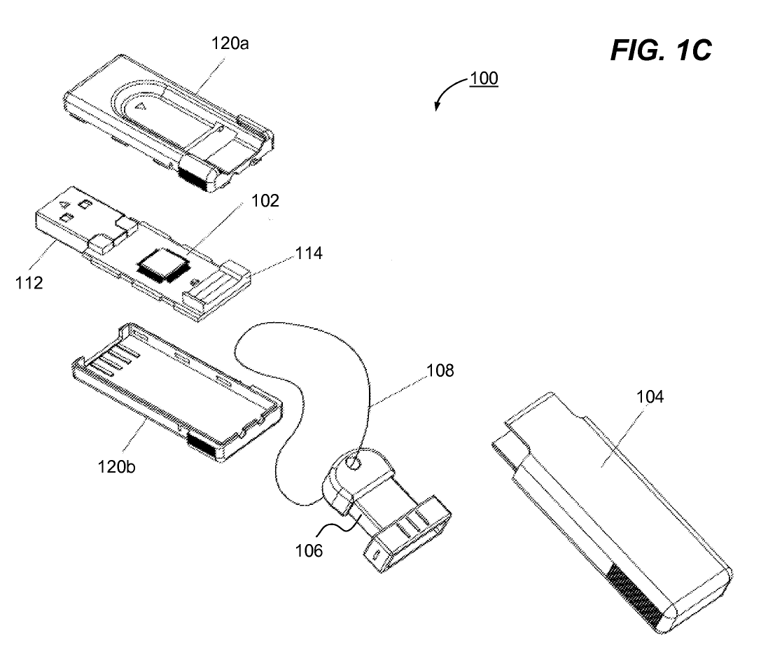

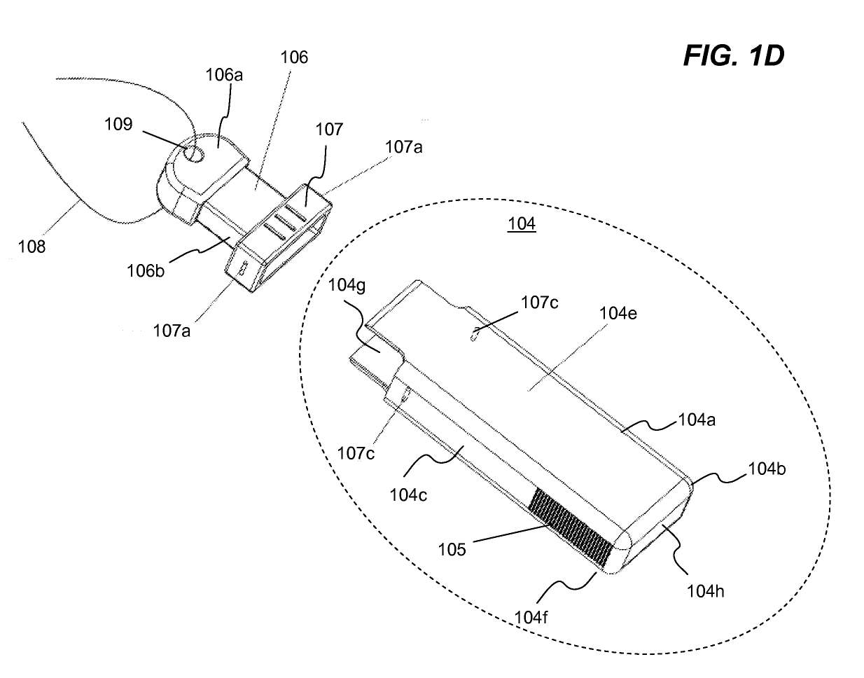

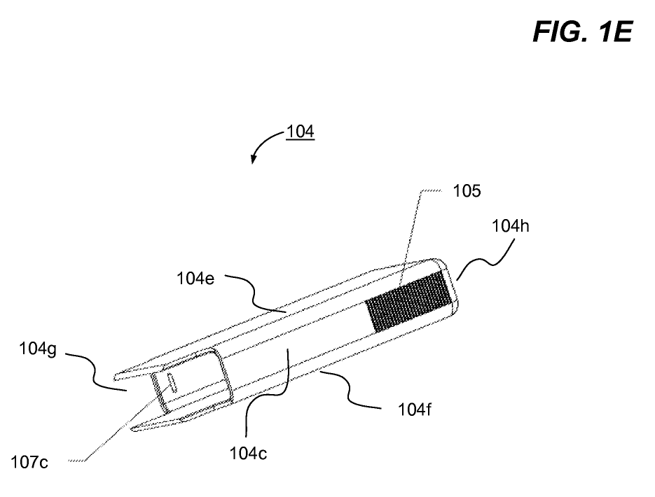

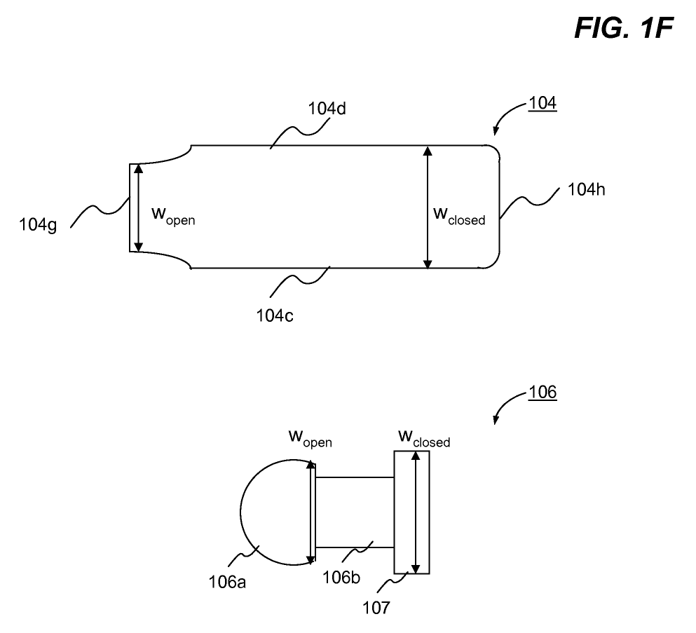

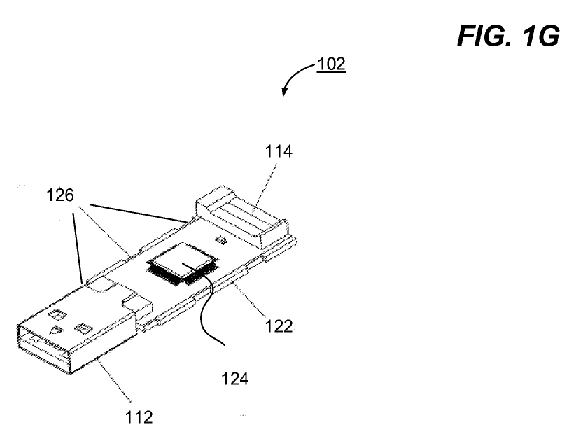

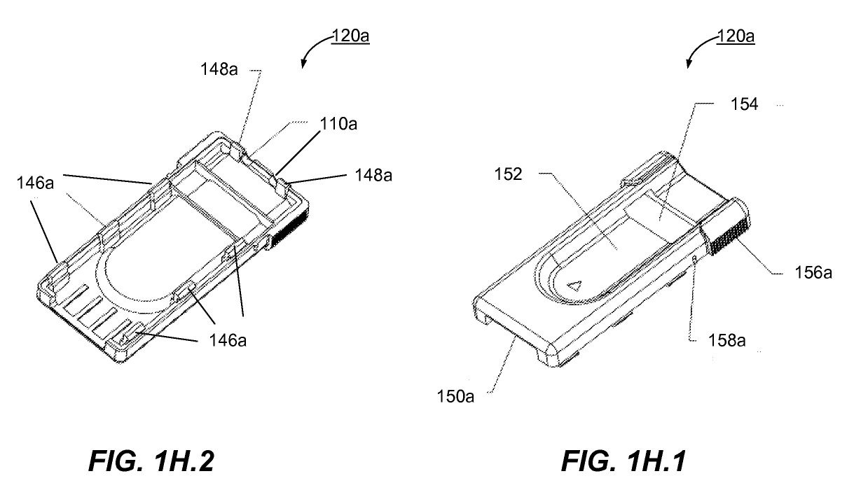

Embodiments of the present invention are discussed herein with reference to FIGS. 1A-7C. However, those skilled in the art will readily appreciate that the detailed description given herein with respect to these figures is for explanatory purposes as the invention extends beyond these limited embodiments.

Referring now to the drawings, in which like numerals refer to like parts throughout several views. FIGS. 1A-1D are perspective views and exploded perspective view of an exemplary Universal Serial Bus (USB) flash memory device 100, according to an embodiment of the present invention. Generally, the USB flash memory device 100 has two configurations: a closed or a “not-in-use” configuration shown in FIG. 1A and an open or a “read-to-be-used or in-use” configuration in FIG. 1B.

The USB flash memory device 100 comprises a USB flash memory drive 101, an improved cap 104 (hereinafter referred to as “cap”), a cap plug 106 and a wire loop 108. The flash memory drive 101 and the cap plug 106 are coupled to the wire loop 108 through two wire loop open slots 110 in the flash memory drive 101 and through a hole or opening 109 in the cap plug 106. The USB flash memory drive 101 is encased by the cap 104 as shown in FIG. 1A. The cap 104 is plugged onto the cap plug 106 shown in FIG. 1B.

The flash memory drive 101 shown in FIG. 1B comprises a USB flash memory core unit 102 (hereinafter referred to as “core unit”) sandwiched between an upper housing 120a and a lower housing 120b shown in an exploded view of FIG. 1C. The upper housing 120a and the lower housing 120b are configured to form an outer shell structure to house the core unit 102. The USB flash memory drive 101 has upper and lower surfaces, front and back ends, and two opposing side walls. Once assembled as shown in FIG. 1B, the USB flash memory drive 101 includes a USB connector 112 located on the front end and a fingerprint sensor 114 (i.e., an interface for scanning fingerprint of a user) located on the upper surface.

The core unit 102, as shown in FIG. 1G, comprises a print circuit board (PCB) 122, a USB connector 112, a fingerprint sensor 114 and a plurality of integrated circuits or chips 124 (e.g., flash memory chip, controller chip, etc.). The USB connector 112 comprises a connector based on the specification of USB. The USB connector 112 is coupled to the PCB 122 electrically and physically such that control signals and power can pass through. The optional fingerprint sensor 114 may be provided by an integrated circuit or chip mounted on the PCB 122. Several chips 124 such as flash memory chip and controller chip are also mounted on the PCB 122. There are conductive paths or traces built in on the PCB 122 such that signals and power can be passed through between the chips (e.g., fingerprint sensor chip, flash memory chip) mounted thereon. Additionally, the PCB 122 comprises six edge cut-outs 126 (three on each edge) configured to provide clearance space for corresponding side tabs 146a on the upper housing 120a.

PCB is a medium means used for mechanically support and electrically connection of electronic components using conductive pathways, or traces, etched from copper sheets laminated onto a non-conductive substrate. The core unit 102 is also referred to as a print circuit board assembly (PCBA).

FIGS. 1H.1 and 1H.2 are top and bottom perspective views showing the upper housing 120a of the USB flash memory drive 101, respectively. Top surface of the top housing 120a comprises an indent space 152 configured for fingerprint sensing area (i.e., space for user's finger) with a cut-out 154 for exposing the fingerprint sensor 114 to a user's finger. Located on the front end of the upper housing 120a is an upper half connector cut-out 150a for the USB connector 112. On the side walls of the upper housing 120a towards the back end are upper half of a plurality of fins 156a and upper half of a pair of protrusion snap-in connectors 158a (only one shown). Other features, shown in FIG. 1H.2, include upper half of two wire loop open slots 110a, two back snap-in tabs 148a along edge of the back end and six side snap-in tabs 146a along edges of the side walls (three on each side).

FIG. 11 is a top perspective view of the lower housing 120b of the USB flash memory drive 101. The lower housing 120b comprises a lower half connector cut-out 150b for the USB connector 112, lower half of the plurality of fins 156b, lower half of the pair of protrusion snap-in connectors 158b (only one shown), lower half of the two wire loop open slots 110b, two corresponding back slots 148b for snap-in tabs 148a at the back end, and six corresponding side slots 146b for snap-in tabs 146a at edges of the side walls (three on each side).

The side 146a and back 148a snap-in tabs are configured for coupling to the corresponding receiving side 146b and back 148b slots such that the upper 110a and the lower 110b housing can be aligned and snapped together to form the outer shell housing with the core unit sandwiched in between. Fins 156 are formed with the upper 156a and lower half 156b fins. A pair of protrusion snap-in connector 158 is formed by the upper 158a and lower 158b half connectors. And two wire loop open slots 110 are formed by the upper 110a and lower 110b half open slots. Fins 156 are configured to provide easier grip for user to insert or remove the USB flash memory drive 101 into a host or the cap 104. A pair of protrusion snap-in connectors 158 is configured for coupling to the corresponding slots 107c located in the inner surface of each of the side walls of the cap 104. Two wire loop open slots 110 are configured for threading through the wire loop 108 shown in FIG. 1A and FIG. 1B.

Shown in FIG. 1D, the cap 104 comprises a substantially slab-shaped hollow structure with rounded edges 104a and rounded corners 104b, having an open end 104g and a closed end 104h, two opposing side walls 104c-d (only one 104c shown in FIGS. 1A-1D), a top surface 104e and a bottom surface 104f (not shown). The cap 104 is configured to substantially encase the entire flash memory drive 101 through the open end 104g shown in FIG. 1A. Additionally, as shown in FIG. 1E, Optional ribs 105 (only one side shown) are located on the side walls 104c-d near the closed end 104h. The cap 104 is typically made of plastic or light metal (e.g., aluminum).

The slab shape of the cap 104 shown in FIGS. 1D and 1E has a length, a width and a thickness. The length is so dimensioned that the distance between the open end 104g and the closed end 104h is substantially equal to length of the USB flash memory drive 101. The width is slightly larger than the distance between two opposing side walls 104c while the thickness is slightly larger than the distance between the top 104e and bottom surface 104f. The width at the open end 104g (Wₒₚₑₙ) is smaller than the width of the cap 104 (W_{closed}) as illustrated in FIG. 1F. The smaller width is configured to accommodate the shape of upper 120a and lower housing 120b. Reduction from the closed end width W_{closed} to the open end width Wₒₚₑₙ follows an arc having a substantially quadratic shape.

Furthermore, the cap 104 comprises a pair of slots 107c located on the inner surface of each of the side walls 104c-d near the open end 104g. The slots 107c are configured to receive either corresponding protrusion snap-in connectors 158 or corresponding protrusion snap-in connectors 107a depending on whether the cap 104 is coupled to the USB flash memory drive 101 (closed configuration of FIG. 1A) or the cap plug 106 (open configuration of FIG. 1B). The protrusion snap-in connectors and the slot form a snug fit such that the cap 104 is securely locked hence not easy to be misplaced. As a result, the present invention overcomes the problem in the prior art approaches.

Also shown in FIG. 1D is the cap plug 106, which comprises a top block 106a a middle block 106b and a plug end block 107. The top block 106a includes a hole or opening 109 configured for threading the wire loop 108 through. The plug end block 107 comprises a brick-shaped block configured to be plugged into the open end 104g of the cap 104. The middle block 106b comprises a narrower block connecting the top end block 106a and the plug end plug 107 together. The plug end block 107 comprises a pair of protrusion snap-in connectors 107a (only one shown) on either side wall. The protrusion snap-in connectors 107a are configured to be snapped into the corresponding slots 107c when the cap 104 is coupled to the cap plug 106. The size of the plug end block 107 is so dimensioned that the plug end block 107 would be snugly fitted in the hollow structure of the cap 104. That means the distance between two protrusion snap-in connectors 107a (i.e., the width of the plug end block 107) is substantially equal to the width W_{closed} (FIG. 1F).of the cap 104. The width of the top end block 106a is substantially equal to the open end width Wₒₚₑₙ (FIG. 1F). Further, the plug end block 107 has a thickness substantially equal to that of the top end block 106a.

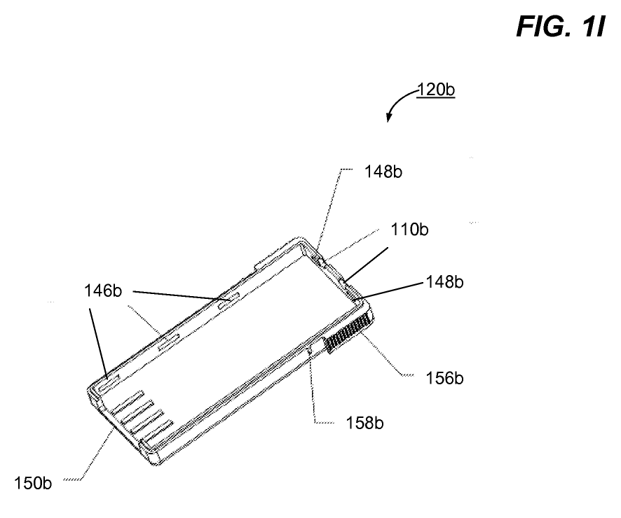

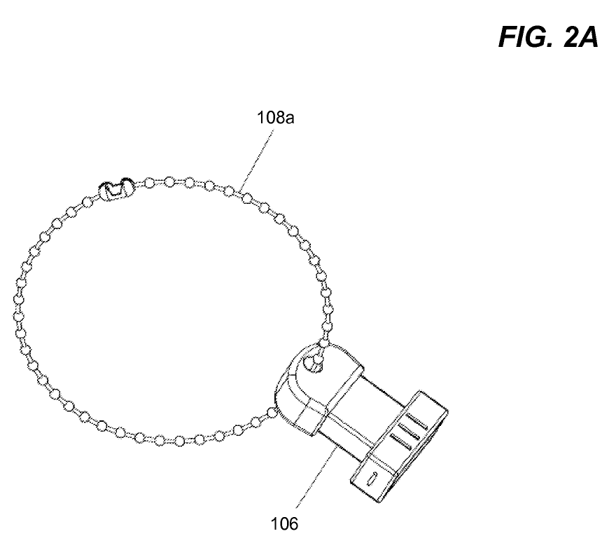

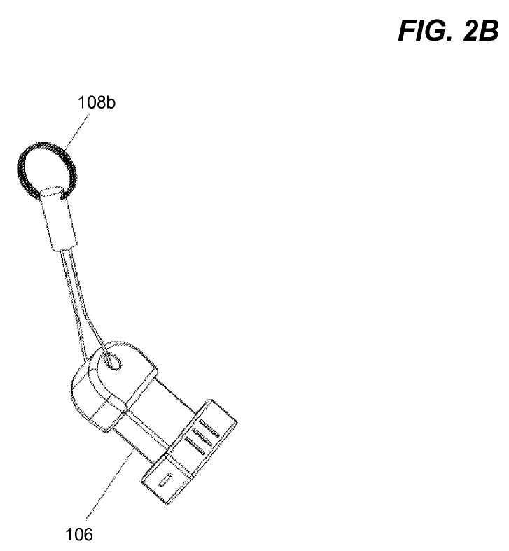

Referring now to FIG. 2A and FIG. 2B, there are shown two alternative wire loops as a first key chain 108a and a second key chain 108b.

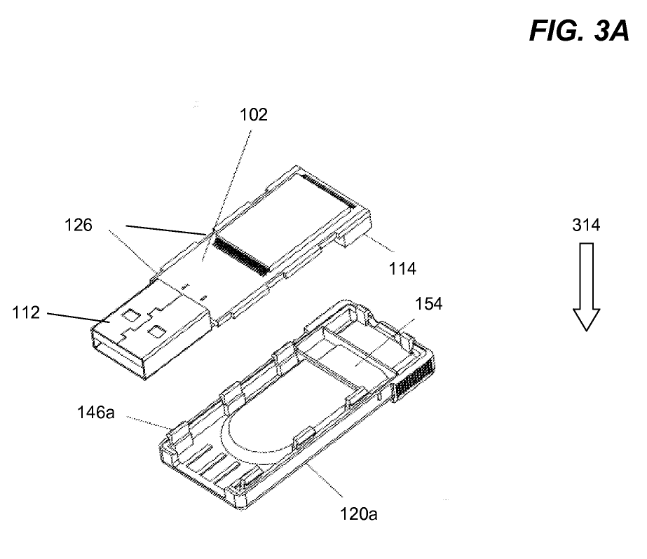

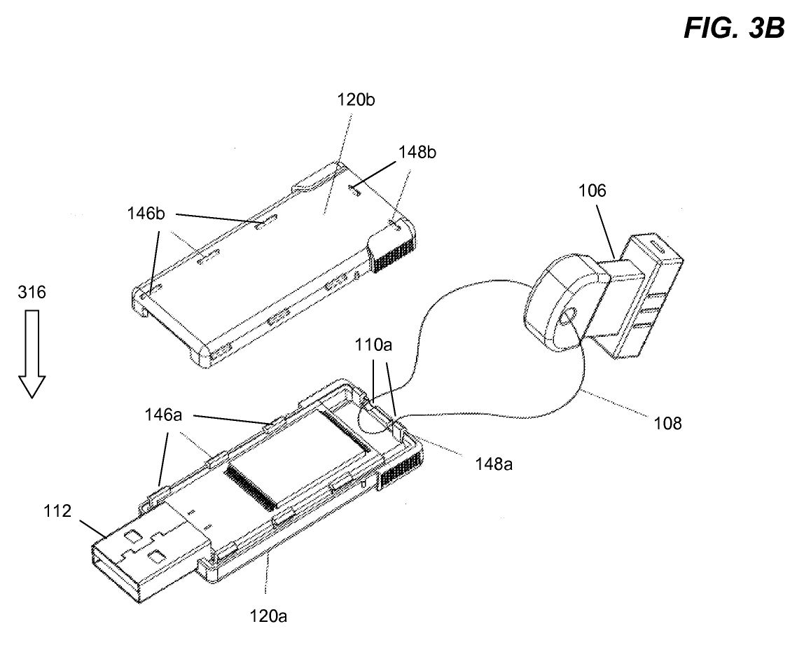

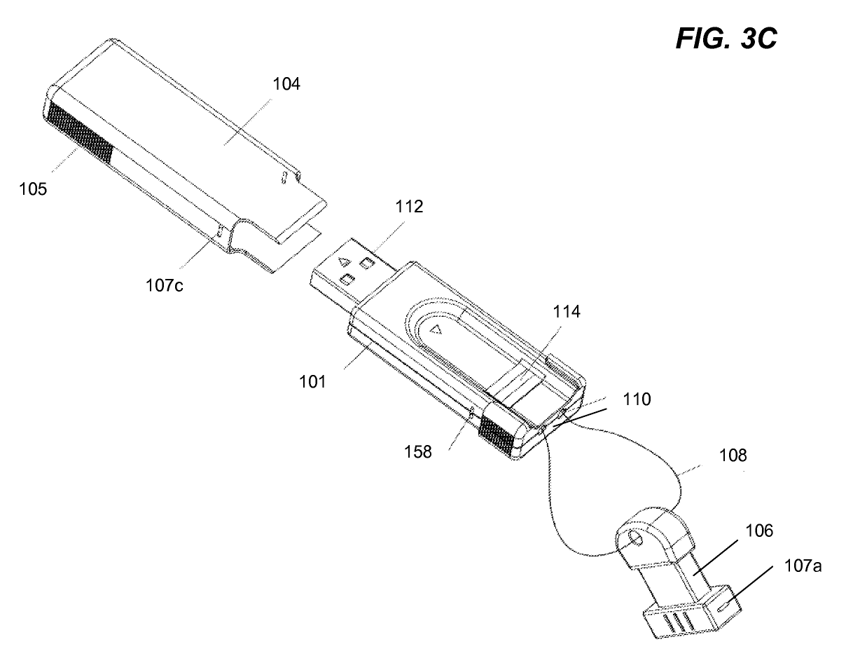

FIGS. 3A-3C collectively depicts perspective views of an assembling sequence of the USB flash memory device 100 of FIG. 1A in accordance with one embodiment of the present invention. The assembly sequence starts with laying the upper housing 120a with top surface facing down as shown in FIG. 3A. Then the core unit 102 is dropped into the upper housing 120a in a direction as indicated by arrow 314. As a result, the fingerprint sensor 114 of the core unit 102 faces towards the upper housing 120a. In order to properly align the core unit 102 with the upper housing 120a, the fingerprint sensor 114 needs to be fitted into and aligned with the finger print cut-out 154 on the upper housing 120a. Another alignment between the core unit 102 and the upper housing 120a is made by aligning six side snap-in tabs 146a with the edge cut-outs 126 of the PCB 122. The USB connector 112 would then be able to fit into the upper half connector cut-out 150a.

After the core unit 102 has been dropped into and aligned with the upper housing 120a, the wire loop 108 including the cap plug 106 threaded therethrough is placed in the upper half of the wire loop open slots 110a as shown in FIG. 3B. In other words, the wire loop 108 is looped through the open slots 110a.

Then, shown in FIG. 3B, the lower housing 120b is pressed onto the partially assembled unit (i.e., the upper housing 120a, the core unit 102, the wire loop 108 and the cap plug 106) in a direction indicated with arrow 316. To align the lower housing 120b to the upper housing 120a, the back slots 148b and the side slots 146b of the lower housing 120b are pressed until the corresponding back snap-in tabs 148a and corresponding side snap-in tabs 146a have been securely locked or snapped in together. Alternatively, an ultrasound welding process may be used to seal the upper housing 120a and the lower housing 120b. Once the upper and lower housing are coupled together, the assembly of the USB flash memory drive 101 has been completed.

Finally, shown in FIG. 3C, the cap 104 is pushed onto the USB flash memory drive 101 until the protrusion snap-in connectors 158 are snapped into the slots 107c of the cap 104.

Alternative embodiments

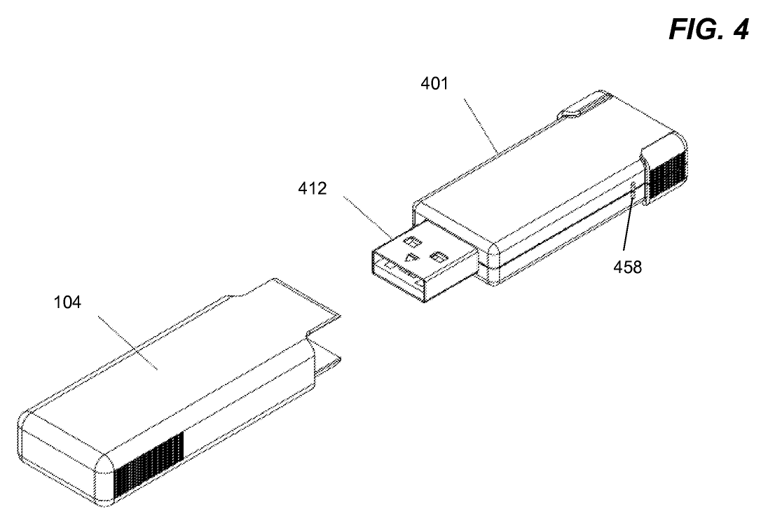

FIG. 4 shows a first alternative USB flash memory drive 401 without a fingerprint sensor in another embodiment of the present invention. The USB flash memory drive 401 comprises a USB connector 412, a pair of protrusion snap-in connectors 458 (only one shown) similar to those on the USB flash memory drive 101. The improved cap 104 is used to cover the USB flash memory drive 401 and is coupled to a cap plug (not shown) in the same manner described in the embodiment for the USB flash memory device 100.

FIG. 5 shows a perspective view of a second alternative USB flash memory core unit 500 in accordance with yet another embodiment of the present invention. The core unit 500 comprises a USB connector 512 and a flex circuit board 501, instead of a PCB. The flex circuit board 501 is configured for providing electrically connection and mechanically support for electric components (e.g., flash memory chip, controller chip, capacitor, resistor, oscillator, etc.). The advantage of using flex circuit is flexible thus allowing more flash memory chips to be mounted on or stacked up, therefore providing higher storage (i.e., flash memory) capacity in a same form factor than PCB based core unit 102 (i.e., PCBA) does.

Flex circuit board, also known as flexible electronics, is a technology for building electronic circuits by depositing electronic devices on flexible substrates such as plastic. Flexible electronics can be made by using the same components used for rigid printed circuit boards. The only thing that needs to change is the substrate, being made flexible, rather than rigid.

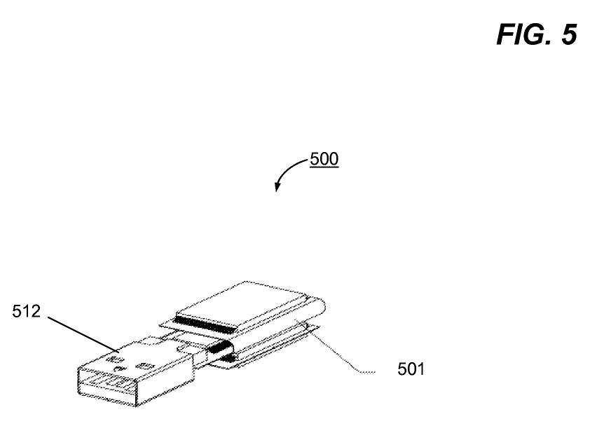

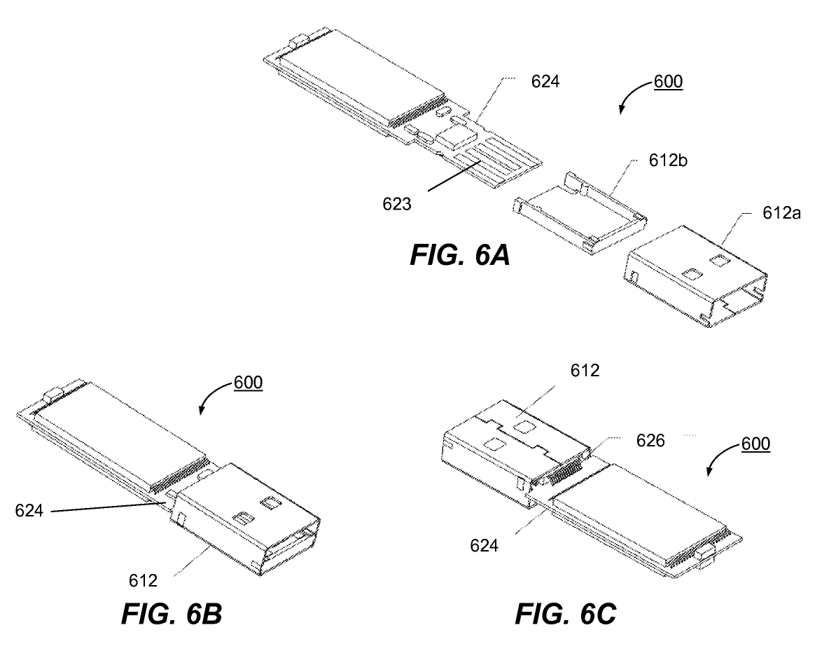

FIG. 6A shows an exploded perspective view of a third alternative USB flash memory core unit 600 in accordance with yet another embodiment of the present invention. The core unit 600 comprises a PCB 624 with metal contact fingers 623 integrated thereon. A metal wrap case 612a and a plastic PCB support 612b are assembled to form a connector 612. The advantage of the third alternative embodiment is that the overall length of the core unit 600 is shorter than that of the core unit 102 of FIG. 1A. This is because partial PCB substrate can be placed inside the metal connector 612a. FIG. 6B and FIG. 6C show top and bottom perspective views of assembled core unit 600, respectively. FIG. 6B shows an assembled connector 612 and the PCB 624. FIG. 6C shows the PCB 624 with a controller 626 mounted thereon.

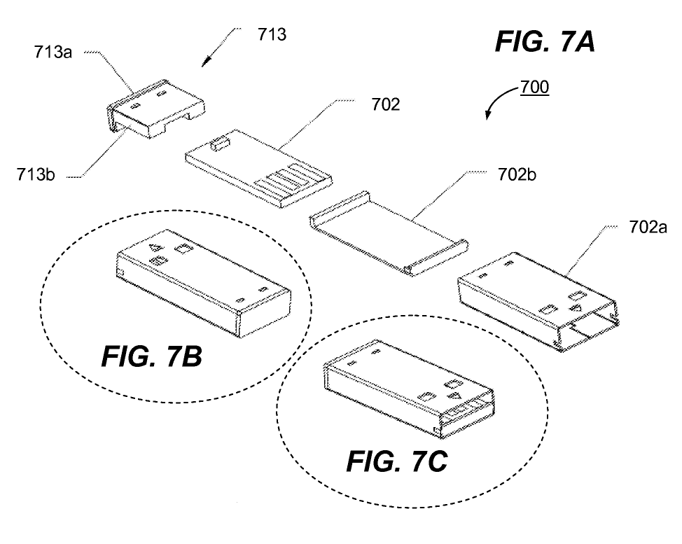

Finally, shown in FIGS. 7A is an exploded perspective view of a fourth alternative USB flash memory drive 700 in accordance with one embodiment of the present invention. The USB flash memory drive 700 comprises a metal casing 702a, a plastic substrate carrier 702b, a flash memory core unit 702 and an end cover piece 713. The flash memory core unit 702 is manufactured using surface mounting technologies (e.g., flip chip, chip scale packaging. etc.). Instead of using PCB or flex circuit board, only a lead frame is required to bound flash memory and controller chip together. The end cover piece 713 comprises a metal end cover plate 713a and a plastic end plug structure 713b. The end cover piece 713 is configured to stabilize the flash memory core unit 702 assembled on the plastic substrate carrier 702b then inside the metal casing 702a. FIG. 7B and FIG. 7C show top and bottom perspective views of the assembled USB flash memory drive 700 of FIG. 7A, respectively.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the exemplary cap has been shown and described as a slab-shaped hollow structure, other shaped structures with similar secure locking mechanisms may be used. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A Universal-Serial-Bus (USB) flash memory device comprising:
a flash memory drive including an outer shell structure and a core unit assembled therein, the outer shell structure is formed by an upper housing and a lower housing;
a cap plug including a top end block, a middle block and a plug end block, the middle block is configured to connect the top end block and the plug end block;
a loop means for linking the flash memory drive and the cap plug together via two open slots on the outer shell housing structure of the flash memory drive and one hole on the top end block of the cap plug; and
a cap configured to substantially encase the entire flash memory drive when the flash memory drive is in a closed configuration and configured to cover the cap plug when the flash memory drive in an open configuration.

2. The device of claim 1, the core unit comprises:
a medium means for mechanically support and electrically connect electrical components with conducting pathways;
a connector means for coupling to a host based on USB specification, the connector means is electrically and physically connected to the medium means;
a flash memory controller mounted on the medium means; and
at least one flash memory integrated circuit mounted on the medium means.

3. The device of claim 2, the core unit further comprises a fingerprint sensor included in a fingerprint processor mounted on the medium means.

4. The device of claim 3, wherein the fingerprint sensor is exposed through a finger print cut-out on the upper housing, which is also configured to provide an indent space for scanning fingerprints.

5. The device of claim 2, wherein the medium means comprises a print circuit board, a flex circuit or a lead frame.

6. The device of claim 2, wherein the connector means comprises a USB connector, a connector made of metal wrap and metal contact fingers configured on the medium means.

7. The device of claim 2, wherein the upper housing and the lower housing are coupled together with a seal means.

8. The device of claim 7, wherein the seal means comprises snap-in tabs and receptacle slots, and the medium means is configured with snap-in tab cut-outs to provide clearance for the snap-in tabs.

9. The device of claim 7, wherein the seal means comprises ultrasound welding.

10. The device of claim 2, wherein the loop means comprises a closed loop key chain.

11. The device of claim 2, wherein the cap comprises a substantially slab-shaped hollow structure with rounded edges and rounded corners, having an open end and a closed end, two opposing side walls, a top surface and a bottom surface, length of the top and bottom surfaces are so dimensioned that the cap substantially covers entire length of the USB flash memory drive in the closed configuration.

12. The device of claim 11, wherein the cap comprises a pair of slots located on the inner surface of each of the side walls configured to couple to a first pair of protrusion snap-in connectors located on the outer shell structure of the USB flash memory drive.

13. The device of claim 12, wherein the pair of slots is configured to couple to a second pair of protrusion snap-in connectors located on either side of the cap plug.

14. The device of claim 11, wherein the open end has a width substantially equal to width of the top end block of the cap plug and the closed end has a width substantially equal to width of the plug end block of the cap plug.

15. The device of claim 2, wherein the middle block has a narrower width than that of the top end block and that of the plug end block.

16. The device of claim 2, wherein the top end block and the plug end block have a substantially same thickness.

17. A Universal-Serial-Bus (USB) flash memory device comprising:
a flash memory drive including an outer shell structure and a core unit assembled therein, the outer shell structure is formed by an upper housing and a lower housing;
a cap plug including a top end block, a middle block and a plug end block, the middle block is configured to connect the top end block and the plug end block;
a wire loop for linking the flash memory drive and the cap plug together via two open slots on the outer shell housing structure of the flash memory drive and one hole on the top end block of the cap plug; and
a cap configure to substantially encase the entire flash memory drive when the flash memory drive is in a closed configuration and configured to cover the cap plug when the flash memory drive in an open configuration.

18. The device of claim 17, wherein the cap comprises a substantially slab-shaped hollow structure with rounded edges and rounded corners, having an open end and a closed end, two opposing side walls, a top surface and a bottom surface, length of the top and bottom surfaces are so dimensioned that the cap substantially covers entire length of the USB flash memory drive in the closed configuration.

19. The device of claim 18, wherein the cap comprises a pair of slots located on inner surface of each of the side walls configured to couple to a first pair of protrusion snap-in connectors located on the outer shell structure of the USB flash memory drive.

20. The device of claim 19, wherein the pair of slots is configured to couple to a second pair of protrusion snap-in connectors located on either side of the cap plug.
